(19) United States
(12) Patent Application Publication
(10) Pub. No.: US 2020/0302418 A1
(43) Pub. Date: Sep. 24, 2020

(54) MEASURING APPARATUS

(71) Applicant: TOSHIBA TEC KABUSHIKI KAISHA, Tokyo (JP)

(72) Inventor: Dayong Chen, Sagamihara Kanagawa (JP)

(21) Appl. No.: 16/689,244

(22) Filed: Nov. 20, 2019

(30) Foreign Application Priority Data
Mar. 20, 2019 (JP) 2019-052958

(51) Int. Cl. G06Q 20/20; G01G 21/22; G06K 7/10

(52) U.S. Cl. CPC G06Q 20/208; A47F 9/046; G06K 7/10544; G01G 21/22

(57) ABSTRACT

According to one embodiment, a measuring apparatus includes a weighing scale, an imaging unit, an identification unit, and an output unit. The weighing scale is configured to measure a weight of merchandise placed in a space for measurement. The imaging unit is configured to image the space for measurement. The identification unit is configured to identify the merchandise placed in the space for measurement, based on a feature of the merchandise shown in an image captured by the imaging unit. The output unit is configured to output predetermined data through which merchandise placed in the space for measurement and a sales price of the merchandise can be specified respectively, based on the weight measured by the weighing scale and an identification result obtained by the identification unit.

### CROSS-REFERENCE TO RELATED APPLICATION

This application is based upon and claims the benefit of priority from Japanese Patent Application No. 2019-052958, filed on Mar. 20, 2019, the entire contents of which are incorporated herein by reference.

### FIELD

Embodiments described herein relate generally to a measuring apparatus, and a method and system relating thereto.

### BACKGROUND

A store system in which a purchaser performs work of registering merchandise, that the purchaser wants to purchase, as merchandise to be purchased, without an intervention of a store assistant is already known.

However, this type of store system of the related art is not able to handle the sale of merchandise being sold by weight.

In these circumstances, it was desired that the purchaser easily registers the merchandise being sold by weight as the merchandise to be purchased.

### DESCRIPTION OF THE DRAWINGS

FIG. 1 is a block diagram showing a main circuit configuration of a measuring apparatus according to a first embodiment and a schematic configuration of a merchandise sales processing system including the measuring apparatus;

FIG. 2 is a perspective view showing an appearance of the measuring apparatus;

FIG. 3 is a flowchart showing a procedure of information processing of a processor, according to the first embodiment;

FIG. 4 is a view showing a screen for confirmation as an example;

FIG. 5 is a flowchart showing a procedure of information processing of the processor, according to a second embodiment;

FIG. 6 is a flowchart showing a procedure of the information processing;

FIG. 7 is a view showing a second screen for confirmation as an example; and

FIG. 8 is a view showing a third screen for confirmation as an example.

### DETAILED DESCRIPTION

Embodiments provide a measuring apparatus that enables a purchaser to easily register merchandise being sold by weight as merchandise to be purchased.

In general, according to one embodiment, a measuring apparatus includes a weighing scale, an imaging unit, an identification unit, and an output unit. The weighing scale is configured to measure a weight of merchandise placed in a space for measurement. The imaging unit is configured to image the space for measurement. The identification unit is configured to identify the merchandise placed in the space for measurement, based on a feature of the merchandise shown in an image captured by the imaging unit. The output unit is configured to output predetermined data through which merchandise placed in the space for measurement and a sales price of the merchandise can be specified respectively, based on the weight measured by the weighing scale and an identification result obtained by the identification unit.

Hereinafter, embodiments will be described using drawings.

The embodiments described herein relate to a measuring apparatus suitable for registering a grocery being sold by weight in a grocery store as merchandise to be purchased. In the following, the term “grocery” includes all foods and drinks that can be sold by weight in a store. That is, for example, “white rice” or “orange juice” may be one of the “groceries”. The measuring apparatus of the embodiment can also be used, even if merchandise other than the food and drink is sold by weight.

### First Embodiment

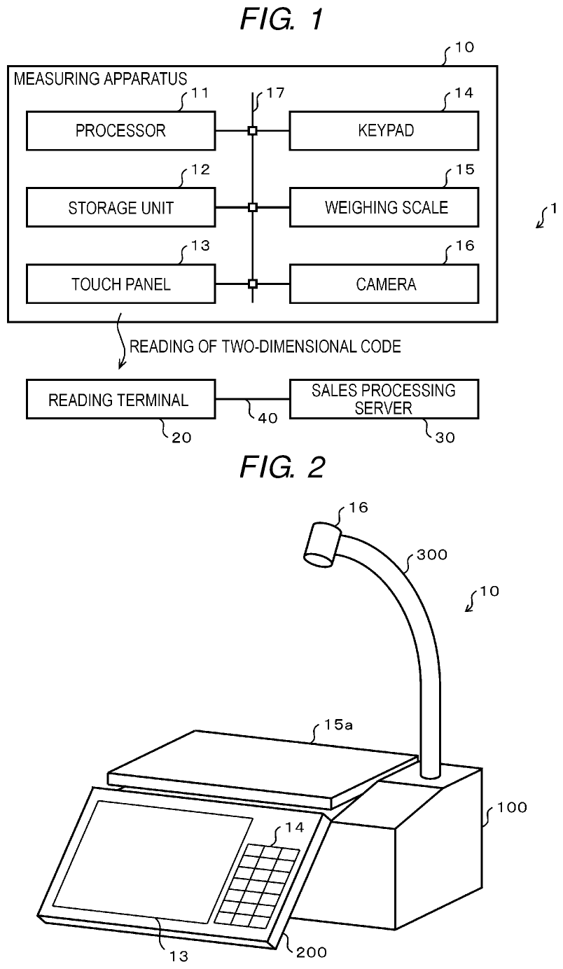

FIG. 1 is a block diagram showing a main circuit configuration of a measuring apparatus 10 according to a first embodiment and a schematic configuration of a merchandise sales processing system 1 including the measuring apparatus 10. FIG. 2 is a perspective view showing an appearance of the measuring apparatus 10. In FIGS. 1 and 2, the same elements are denoted by the same reference numerals.

As shown in FIG. 1, the measuring apparatus 10 includes a processor 11, a storage unit 12, a touch panel 13, a keypad 14, a weighing scale 15, a camera 16, and a transmission path 17.

The processor 11, the storage unit 12, and the weighing scale 15 are contained in a housing 100 shown in FIG. 2. The touch panel 13 and the keypad 14 are attached to a control panel 200 shown in FIG. 2. The camera 16 is attached to a tip of a mounting arm 300 shown in FIG. 2. A base end of the mounting arm 300 is fixed to the housing 100.

The processor 11 and the storage unit 12 configure a computer for executing information processing for realizing various functions as the measuring apparatus 10. The processor 11 corresponds to a central part of the computer. The processor 11 executes information processing according to an information processing program such as an operating system, middleware, and an application program.

The storage unit 12 corresponds to a main storage part of the computer. The storage unit 12 includes a nonvolatile memory area and a volatile memory area. The storage unit 12 stores the information processing program in the nonvolatile memory area. The storage unit 12 may store data necessary for the processor 11 to execute processing for controlling each unit, in the nonvolatile or volatile memory area. One of the data stored in the storage unit 12 is a merchandise database. The merchandise database is a collection of record data associated with each grocery that is merchandise to be sold by weight using the measuring apparatus 10. The record data includes, for example, information such as a merchandise code, a merchandise name, and a price per unit weight, for identifying the associated grocery. However, the measuring apparatus 10 is configured to have a function of communicating through a communication network, and a merchandise database stored in another server may be referred to via a communication network. In this case, the storage unit 12 does not store the merchandise database. The storage unit 12 uses the volatile memory area as a work area in which data is appropriately rewritten by the processor 11. The storage unit 12 may include an auxiliary storage device corresponding to an auxiliary storage part of the computer. As the auxiliary storage device, for example, an electric erasable programmable read-only memory (EEPROM), a hard disc drive (HDD), a solid state drive (SSD), or other known various storage devices can be appropriately applied. The auxiliary storage device stores data used by the processor 11 to perform various processing and data generated by the processing by the processor 11. A part of the information processing program may be stored in the auxiliary storage device.

The touch panel 13 displays various screens for notifying an operator of various types of information. The touch panel 13 inputs various instructions by the operator by inputting a touch operation on the screen.

The keypad 14 is formed by arranging a plurality of keys. The keypad 14 inputs various instructions by the operator by inputting key operations.

In the present embodiment, the touch panel 13 and the keypad 14 are attached to the control panel 200 side by side as shown in FIG. 2. The control panel 200 is attached to the housing 100 such that tilt with respect to the housing 100 can be changed such that an orientation of the touch panel 13 and the keypad 14 can be changed.

The weighing scale 15 includes a scale pan 15a disposed on an outside of the housing 100. The weighing scale 15 is configured to measure a weight of merchandise placed in the scale pan 15a.

The camera 16 is supported by the mounting arm 300 in a state in which an above side of the scale pan 15a is in a field of view. The camera 16 images an inside of the field of view and outputs image data corresponding to an image within the field of view. In the image that the image data represents, when merchandise is placed on the scale pan 15a, the merchandise is projected. The camera 16 is an example of the imaging unit.

The transmission path 17 includes an address bus, a data bus, a control signal line, and the like, and through the transmission path 17, data and control signals are transferred between connected units.

A reading terminal 20 optically reads a code pattern in which data such as a merchandise code for identifying merchandise is represented to be optically readable. The code pattern is, for example, various bar-codes such as a Japanese article number (JAN) symbol or a two-dimensional code such as a QR code (registered trademark). Then, the reading terminal 20 notifies a sales processing server 30 of data that the read code pattern represents, via a communication network 40. The reading terminal 20 is, for example, a cart terminal attached to a shopping cart. Alternatively, the reading terminal 20 is an information terminal carried by a purchaser.

The sales processing server 30 adds merchandise specified by the data that the reading terminal 20 notifies thereof to a merchandise list, thereby registering the merchandise as merchandise to be purchased for a purchaser who is using the reading terminal 20. If the purchaser who is using the reading terminal 20 leaves a store, in the sales processing server 30, a price for the merchandise to be purchased registered for the purchaser is paid.

The communication network 40 is typically a local area network (LAN). However, as the communication network 40, the Internet, a virtual private network (VPN), a LAN, a public communication network, a mobile communication network, a dedicated line, or the like can be used alone or in an appropriate combination. The communication network 40 may be any of a wired type or a wireless type, or both thereof may be used in combination. In particular, a wireless connection is suitable between the reading terminal 20 and the communication network 40.

The measuring apparatus 10 stores the information processing program described in information processing to be described later in the storage unit 12. The information processing program may be stored in the storage unit 12 when hardware of the measuring apparatus 10 is transferred, or may be transferred separately from the hardware. In the latter case, the information processing program is transferred by being recorded on a removable recording medium such as a magnetic disk, a magneto-optical disk, an optical disk, and a semiconductor memory, or is transferred via a network. In the latter case, a case is assumed that the information processing program is provided as a version update program and can be replaced with another similar information processing program already stored in the storage unit 12.

Next, operations of the measuring apparatus 10 and the merchandise sales processing system 1 configured as described above will be described. The content of the processing to be described below is an example, and a change of a procedure of a part of processing, omission of a part of processing, or addition of other processing can be made as appropriate.

When a purchaser enters a store, the purchaser checks in with the reading terminal 20 used for merchandise registration. The reading terminal 20 acquires a purchaser code for identifying the purchaser in the check-in, and notifies the sales processing server 30 of shopping start with the notification of the purchaser code. According to reception of the notification, the sales processing server 30 associates a terminal code for checking the reading terminal 20 that made the notification with the purchaser code notified thereof, and generates table data representing the merchandise list (hereinafter, referred to as a merchandise table). The check-in may be performed at a check-in terminal installed at an entrance.

If a code pattern such as a bar-code representing the merchandise code is marked on merchandise to be purchased, the purchaser causes the code pattern to be read by the reading terminal 20. If the reading terminal 20 reads the code pattern, the reading terminal 20 notifies the sales processing server 30 of at least the merchandise code of data that the code pattern represents, via the communication network 40. According to reception of notification, the sales processing server 30 updates the merchandise table associated with the reading terminal 20 that is a notification source such that the merchandise identified by the merchandise code notified thereof is included as merchandise to be purchased. If the code pattern represents a sales price of merchandise, the reading terminal 20 also notifies the sales processing server 30 of the sales price. In this case, the sales processing server 30 associates the sales price notified thereof with merchandise to be purchased to include the price in the merchandise table. That is, the sales processing server 30 registers the merchandise that the purchaser intends to purchase as merchandise to be purchased as described above.

The purchaser puts a grocery intended to be purchased in a predetermined container by the preferred amount and places the container on the scale pan 15a of the measuring apparatus 10.

When the measuring apparatus 10 is in a normal operation state, the processor 11 executes information processing to be described below according to an information processing program stored in the storage unit 12.

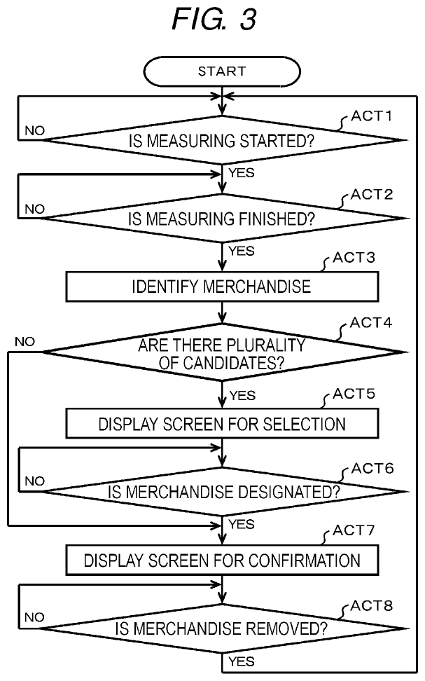

FIG. 3 is a flowchart showing a procedure of the information processing of the processor 11, according to the first embodiment.

As ACT1, the processor 11 waits for starting of measuring. For example, if the weight measured by the weighing scale 15 remains 0, the processor 11 determines that measuring is not started. Then, as described above, if the grocery is placed on the scale pan 15a of the measuring apparatus 10, the weight measured by the weighing scale 15 is not at 0. Then, the processor 11 determines as YES that the measuring is started, and proceeds to ACT2.

As ACT2, the processor 11 waits for measuring to be finished. For example, if the weight measured by the weighing scale 15 fluctuates, the processor 11 determines that measuring is in progress. Then, for example, if the weight measured by the weighing scale 15 remains at a value other than 0 for a predetermined period without fluctuation, the processor 11 determines as YES that the measuring is finished, and proceeds to ACT3.

As ACT3, the processor 11 identifies which merchandise is the grocery placed on the scale pan 15a. In this case, in the image that the image data output by the camera 16 represents, the grocery put on the scale pan 15a is projected. Therefore, the merchandise is identified from a feature of an appearance of the grocery on the image. For the identification of the merchandise, a well-known object recognition technique can be used. Thus, the processor 11 executes information processing based on the information processing program. Accordingly, the computer including the processor 11 as a central part functions as an identification unit.

As ACT4, the processor 11 checks whether there are a plurality of candidates. That is, if there are a plurality of groceries having similar appearances, there may be a case where the plurality of groceries cannot be narrowed down to one, based on the feature appearing in the image, that the image data represents, output from the camera 16. In this case, a plurality of candidates is generated. In this case, the processor 11 determines a result as YES, and proceeds to ACT5.

As ACT5, the processor 11 causes a screen for selection to be displayed on the touch panel 13. For example, the screen for selection is a screen that represents each of the plurality of candidates and guides a purchaser to designate the grocery placed on the scale pan 15a among the candidates. If the screen for selection is displayed, the purchaser designates one of the candidates by touching the touch panel 13 or operating the keypad 14.

As ACT6, the processor 11 waits for the grocery placed on the scale pan 15a to be designated among the candidates. Then, the processor 11 determines a result as YES if it is confirmed that the operation for designating the grocery is performed, and proceeds to ACT7. In ACT4, the processor 11 determines a result as NO if the grocery can be identified in ACT3, passes ACT5 and ACT6, and proceeds to ACT7.

As ACT7, the processor 11 causes a screen for confirmation to be displayed on the touch panel 13.

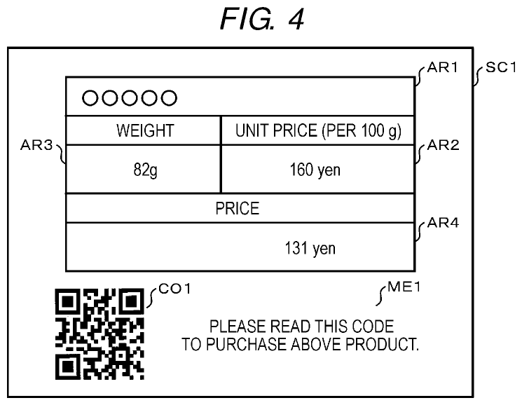

FIG. 4 is a view showing a screen for confirmation SC1 as an example.

The screen for confirmation SC1 includes display areas AR1, AR2, AR3, and AR4, a text message ME1, and a two-dimensional code CO1.

The display area AR1 is an area for displaying a merchandise name. The display area AR2 is an area for displaying a price per unit weight, that is, a unit price. The processor 11 acquires the merchandise name and the unit price included in the merchandise database in association with the merchandise code of the grocery identified in ACT3 or the grocery specified in ACT6, from the storage unit 12, and causes the merchandise name and the unit price to be displayed on the display areas AR1 and AR2, respectively. In the screen for confirmation SC1 shown in FIG. 4, the merchandise name is omitted and is indicated as “OOOOO”. The screen for confirmation SC1 shown in FIG. 4 is an example in which the unit price is 160 yen.

The display area AR3 is an area for displaying a measured weight. The processor 11 causes the weight measured by the weighing scale 15 to be displayed on the display area AR3. The screen for confirmation SC1 shown in FIG. 4 is an example in which the measured weight is “82 g”.

The display area AR4 is an area for displaying the sales price of the grocery placed on the scale pan 15a. The processor 11 causes the amount of money obtained by multiplying the unit price by a value obtained from [Measured weight/Unit weight] to be displayed on the display area AR4. The screen for confirmation SC1 shown in FIG. 4 is an example in which a sales price is 131 yen.

The display areas AR1 to AR4 are also included in another screen for confirmation. However, the merchandise name, measured weight, unit price, and sales price shown in the display areas AR1 to AR4 may be different from those in another screen for confirmation.

The two-dimensional code CO1 represents at least the merchandise code of the grocery identified in ACT3 or the grocery designated in ACT6 and price specifying data that enables the sales price shown in the display area AR4 to be specified in the sales processing server 30. The price specifying data is typically the sales price shown in the display area AR4. However, the price specifying data may be the unit price and the measured weight shown in the display areas AR2 and AR3. In this case, the sales processing server 30 can specify the sales price using the calculation described above. The price specifying data may be only the measured weight shown in the display area AR3. In this case, by making sales processing server 30 accessible to a merchandise database having the same content as that stored in the storage unit 12, the sales price can be specified with the sales processing server 30 using the calculation described above, from the unit price obtained from the merchandise database and the measured weight that the price specifying data represents. The two-dimensional code CO1 may be replaced with another two-dimensional code having a different pattern in another screen for confirmation.

The text message ME1 represents a message that prompts the purchaser to cause the two-dimensional code CO1 to be read by the reading terminal 20, if the grocery placed on the scale pan 15a is merchandise to be purchased. The content of the message may be any content. For example, the content is determined by a designer or an administrator of the measuring apparatus 10. The text message ME1 is also included in another screen for confirmation.

The touch panel 13 is an example of a display device. The processor 11 causes a two-dimensional code as an optically readable code pattern representing the merchandise code and the price specifying data to be displayed on the touch panel 13. In this case, the merchandise code and the price specifying data correspond to predetermined data through which merchandise placed on the scale pan 15a as a space for measurement and a sales price of the merchandise can be specified respectively, based on the weight measured by the weighing scale 15 and the identification result obtained in ACT3. Thus, the processor 11 executes information processing based on the information processing program. Accordingly, the computer including the processor 11 as a central part functions as a control unit. In addition, the processor 11 realizes a function as the output unit in cooperation with the touch panel 13 and a function as the control unit.

For example, if the purchaser checks the screen for confirmation SC1 and determines to purchase the grocery placed on the scale pan 15a, the purchaser causes the two-dimensional code CO1 to be read by the reading terminal 20 according to the guidance in the text message ME1.

If the reading terminal 20 reads the two-dimensional code of the screen for confirmation, the reading terminal 20 notifies the sales processing server 30 of the merchandise code and the price specifying data shown in the two-dimensional code via the communication network 40. According to reception of notification, the sales processing server 30 updates the merchandise table associated with the reading terminal 20 that is a notification source such that the merchandise identified by the merchandise code notified thereof is included as merchandise to be purchased. That is, the sales processing server 30 registers the merchandise that the purchaser intends to purchase as merchandise to be purchased as described above. Also, the sales processing server 30 causes the sales price specified from the price specifying data notified thereof to be included in the merchandise table as a sales price of the registered merchandise to be purchased.

If the purchaser finishes registering the grocery placed on the scale pan 15a as merchandise to be purchased in this manner, the purchaser removes the grocery from the scale pan 15a.

As ACT8, the processor 11 waits for the grocery placed on the scale pan 15a to be removed. For example, if the weight measured by the weighing scale 15 is at 0, the processor 11 determines as YES that the grocery is removed. In this case, the processor 11 returns to a standby state of ACT1 and prepares for another grocery to be placed on the scale pan 15a.

As described above, according to the measuring apparatus 10, a purchaser can easily register merchandise being sold by weight as merchandise to be purchased.

However, for example, if a purchaser leaves the store, the sales processing server 30 pays for the merchandise to be purchased shown in the merchandise table associated with the purchaser using a credit card previously linked to the purchaser. In this manner, a store where the merchandise sales processing system 1 is provided can be a self-service store. According to the present application, it is possible to sell merchandise being sold by weight, in this self-service store. For example, the sales processing server 30 regards that a purchaser left the store, if the purchaser performs an operation of declaring of leaving the store with a checkout terminal provided in a checkout corner. Alternatively, for example, the sales processing server 30 regards that a purchaser left the store, if a sensor detects that the purchaser passed through a checkout gate.

The payment may be performed with the checkout terminal installed at the checkout corner. In this case, the payment may be a face-to-face type that a store assistant operates the checkout terminal, or a self type that the purchaser operates the checkout terminal.

The reading terminal 20 may generate, save, and update the merchandise table. In this case, notifying the sales processing server 30 of the merchandise code can be omitted. If the payment is requested, the reading terminal 20 notifies a server that performs credit payment or the check-out terminal, of payment data for the payment according to the merchandise table. The payment data may be data through which the amount of money to be paid can be recognized by a server or the checkout terminal. Whether or not the merchandise table includes the payment data is optional.

### Second Embodiment

A second embodiment can be implemented by a hardware configuration similar to the measuring apparatus 10 according to the first embodiment. Therefore, illustration and description of the hardware configuration as the second embodiment are omitted.

The second embodiment is different from the first embodiment, in the information processing program stored in the storage unit 12 and processing of the processor 11 based on the information processing program.

When the measuring apparatus 10 is in a normal operation state, the processor 11 executes information processing to be described below according to an information processing program stored in the storage unit 12.

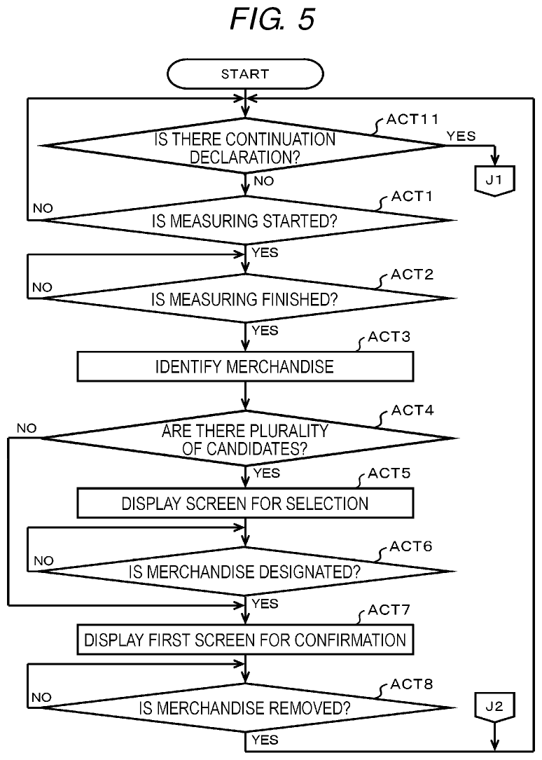

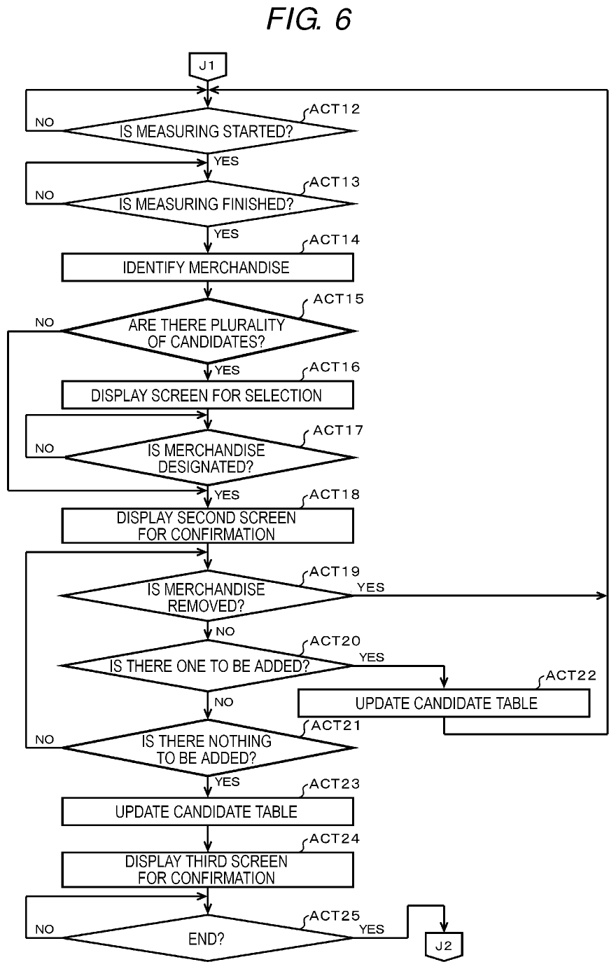

FIGS. 5 and 6 are flowcharts showing a procedure of the information processing of the processor 11, according to the second embodiment. ACT1 to ACT8 in FIG. 5 are the same as the processing shown in FIG. 3 of the first embodiment, and thus description thereof will not be repeated.

As ACT11, the processor 11 checks whether or not continuation declaration is made. Then, the processor 11 determines a result as NO if it is not confirmed that the declaration is made, and proceeds to ACT1. Then, the processor 11 returns to ACT11, if the processor 11 determines the result as NO in ACT1 because it is not confirmed that the measuring is started.

Thus, as ACT11 and ACT1, the processor 11 waits for the continuation declaration to be made or measuring to start. If the processor 11 determines the result as YES in ACT1 by starting measuring, the processor 11 executes the processing after ACT2 in the same manner as in the first embodiment. If the processor 11 determines the result as YES in ACT8, the processor 11 returns to the standby state of ACT11 and ACT1. However, in the second embodiment, a screen for confirmation displayed in ACT7 is referred to as a first screen for confirmation, and is distinguished from another screen for confirmation described below.

According to the processing of ACT1 to ACT8 similar to the processing of the first embodiment, it is necessary to read the two-dimensional code with the reading terminal 20 every time the measuring of one grocery is finished. On the other hand, in the second embodiment, it is allowed to continuously measure a plurality of groceries. If this continuous measuring is performed, the purchaser makes a continuation declaration by touching the touch panel 13 or operating the keypad 14. If the processor 11 confirms that the continuous declaration is made, the processor 11 determines a result as YES in ACT11, and proceeds to ACT12 in FIG. 6.

As ACT12, the processor 11 waits for starting of measuring. For example, if the weight measured by the weighing scale 15 remains 0, the processor 11 determines that measuring is not started. Then, as described above, if the grocery is placed on the scale pan 15a of the measuring apparatus 10, the weight measured by the weighing scale 15 is not at 0. Then, the processor 11 determines as YES that the measuring is started, and proceeds to ACT13.

As ACT13, the processor 11 waits for measuring to be finished. For example, if the weight measured by the weighing scale 15 fluctuates, the processor 11 determines that measuring is in progress. Then, for example, if the weight measured by the weighing scale 15 remains at a value other than 0 for a predetermined period without fluctuation, the processor 11 determines as YES that the measuring is finished, and proceeds to ACT14.

As ACT14, the processor 11 identifies which merchandise is the grocery placed on the scale pan 15a. In this case, in the image that the image data output by the camera 16 represents, the grocery put on the scale pan 15a is projected. Therefore, the merchandise is identified from a feature of an appearance of the grocery on the image. For the identification of the merchandise, a well-known object recognition technique can be used.

As ACT15, the processor 11 checks whether there are a plurality of candidates. That is, if there are a plurality of groceries having similar appearances, there may be a case where the plurality of groceries cannot be narrowed down to one, based on the feature appearing in the image, that the image data represents, output from the camera 16. In this case, a plurality of candidates is generated. In this case, the processor 11 determines a result as YES, and proceeds to ACT16.

As ACT16, the processor 11 causes a screen for selection to be displayed on the touch panel 13. For example, the screen for selection is a screen that represents each of the plurality of candidates and guides a purchaser to designate the grocery placed on the scale pan 15a among the candidates. If the screen for selection is displayed, the purchaser designates one of the candidates by touching the touch panel 13 or operating the keypad 14.

As ACT17, the processor 11 waits for the grocery placed on the scale pan 15a to be designated from the candidates. Then, the processor 11 determines a result as YES if it is confirmed that the operation for designating the grocery is performed, and proceeds to ACT18. In ACT15, the processor 11 determines a result as NO if the grocery can be identified in ACT14, passes ACT16 and ACT17, and proceeds to ACT18.

As ACT18, the processor 11 causes a second screen for confirmation to be displayed on the touch panel 13.

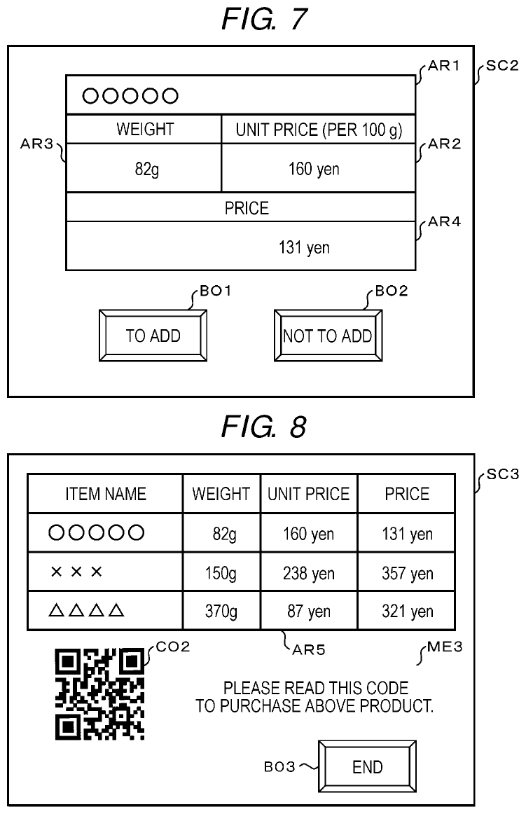

FIG. 7 is a view showing a second screen for confirmation SC2 as an example. In FIG. 7, the same display elements as those shown in FIG. 4 are denoted by the same reference numerals, and detailed description thereof will not be repeated.

The second screen for confirmation SC2 includes display areas AR1, AR2, AR3, and AR4, and buttons BO1 and BO2.

That is, the second screen for confirmation SC2 represents buttons BO1 and BO2 in place of the text message ME1 and the two-dimensional code CO1 in the first screen for confirmation. These buttons BO1 and BO2 are also included in another screen for confirmation.

The button BO1 is an operation button for a purchaser to declare that another grocery is to be measured. The button BO2 is an operation button for a purchaser to declare that measuring on a plurality of groceries is finished.

If a purchaser determines to purchase a grocery with contents displayed in the display areas AR1, AR2, AR3, and AR4 related to a grocery during measuring, the purchaser touches either the buttons BO1 or BO2. In other words, the purchaser touches the button BO1, if the purchaser wants to continue measuring another grocery. The purchaser touches the button BO2, if the purchaser wants to finish measuring. If the purchaser tries re-measuring for the grocery during measuring or cancels the purchase of the grocery, the purchaser removes the grocery from the scale pan 15a without touching either the buttons BO1 or BO2.

As ACT19, the processor 11 checks the grocery placed on the scale pan 15a is removed. For example, if the weight measured by the weighing scale 15 does not remain at 0, the processor 11 determines a result as NO, and proceeds to ACT20.

As ACT20, the processor 11 checks whether or not a declaration of measuring an additional grocery is made. Then, the processor 11 determines a result as NO if it is not confirmed that the button BO1 is touched, and proceeds to ACT21.

As ACT21, the processor 11 checks whether or not a declaration of not measuring an additional grocery is made. Then, the processor 11 determines a result as NO if it is not confirmed that the button BO2 is touched, and returns to ACT19.

As ACT19 to ACT21, the processor 11 waits for the grocery placed on the scale pan 15a to be removed, or any declaration of measuring or not measuring the additional grocery to be made. For example, in ACT19, if the weight measured by the weighing scale 15 is at 0, the processor 11 determines a result as YES that the grocery is removed. In this case, the processor 11 returns to a standby state of ACT12 and prepares for another grocery to be placed on the scale pan 15a.

In ACT20, if the purchaser touches the button BO1 as described above and this touching is detected by the touch panel 13, the processor 11 determines a result as YES and proceeds to ACT22.

As ACT22, the processor 11 updates the table data that represents a list of groceries that will be subject to continuous measurement this time. The grocery to be continuously measured is not yet determined to be merchandise to be purchased and is a merchandise candidate. Therefore, the table data is referred to as a candidate table here. In this case, the processor 11 returns to a standby state of ACT12 and prepares for subsequent grocery to be placed on the scale pan 15a.

Thus, the processor 11 repeats a loop of ACT12 to ACT22 as groceries are successively placed on the scale pan 15a. If the processor 11 executes ACT21 at first in repeating of the loop, the processor 11 generates a new candidate table including one record data representing a measured weight, a unit price, and a sales price in association with the merchandise code of the grocery identified in ACT14 or the grocery designated in ACT17. If the processor 11 executes ACT21 in the second time or later, the processor 11 adds new record data showing a measured weight, a unit price, and a sales price to the candidate table, in association with a merchandise code of a grocery newly placed on the scale pan 15a.

In ACT21, if the purchaser touches the button BO2 as described above and this touching is detected by the touch panel 13, the processor 11 determines a result as YES and proceeds to ACT23.

As ACT23, the processor 11 updates the candidate table in the same manner as ACT22.

As ACT24, the processor 11 causes a third screen for confirmation to be displayed on the touch panel 13.

FIG. 8 is a view showing a third screen for confirmation SC3 as an example.

The third screen for confirmation SC3 includes a display area AR5, a two-dimensional code CO2, a text message ME3, and a button BO3.

The display area AR5 shows information included in the candidate table as a table. The display area AR5 is also included in another screen for confirmation. However, a merchandise name, a measured weight, a unit price, and a sales price shown in the display area AR5 may be different from those in another screen for confirmation.

The two-dimensional code CO2 represents at least a merchandise code shown in the candidate table and price specifying data that enables the sales price to be specified in the sales processing server 30. The price specifying data is the same as in the first embodiment. The two-dimensional code CO2 may be replaced with another two-dimensional code having a different pattern in another screen for confirmation.

The text message ME3 represents a message that prompts the purchaser to cause the two-dimensional code CO2 to be read by the reading terminal 20, if the groceries shown in the display area AR5 as the table are merchandise to be purchased. The content of the message may be any content. For example, the content is determined by a designer or an administrator of the measuring apparatus 10. The text message ME2 is also included in another screen for confirmation.

The button BO3 is an operation button for a purchaser to declare that reading of the two-dimensional code CO2 is completed.

For example, if the purchaser checks the third screen for confirmation SC3 and determines to purchase the groceries shown in the display area AR5 as the table, the purchaser causes the two-dimensional code CO2 to be read by the reading terminal 20 according to the guidance in the text message ME3.

If the reading terminal 20 reads the two-dimensional code of the screen for confirmation, the reading terminal 20 notifies the sales processing server 30 of all the merchandise code and the price specifying data shown in the two-dimensional code CO2 via the communication network 40. According to reception of notification, the sales processing server 30 updates the merchandise table associated with the reading terminal 20 that is a notification source such that all the merchandise identified by the merchandise code notified thereof is included as merchandise to be purchased. That is, the sales processing server 30 registers the merchandise that the purchaser intends to purchase as merchandise to be purchased as described above. Also, the sales processing server 30 causes the sales price specified from the price specifying data notified thereof to be included in the merchandise table as a sales price of the registered merchandise to be purchased.

If the purchaser causes the two-dimensional code CO2 to be read by the reading terminal 20, the purchaser touches the button BO3.

The processor 11 waits for reading of the two-dimensional code to be completed. In ACT25, if the purchaser touches the button BO3 and this touching is detected by the touch panel 13, the processor 11 determines a result as YES. In this case, the processor 11 returns to a standby state of ACT11 and ACT1 in FIG. 5, and prepares for another grocery to be placed on the scale pan 15a.

As above, in the measuring apparatus 10 according to the second embodiment, it is possible for a purchaser to easily register merchandise being sold by weight as merchandise to be purchased.

In addition, according to the measuring apparatus 10 in the second embodiment, the merchandise code and the price specifying data relating to a plurality of groceries can be acquired by the reading terminal 20 by reading the two-dimensional code at once. Therefore, an operation performed by the purchaser can be simplified compared to reading of the two-dimensional code performed for each grocery.

Also, according to the measuring apparatus 10 in the second embodiment, a purchaser can optionally select and use a method of registering a grocery as merchandise to be purchased every time measuring of each grocery is finished, and a method of registering a plurality of groceries together as the merchandise to be purchased after the measuring of the plurality of groceries is finished. Accordingly, registration is performed by a method that meets needs of the purchaser.

Also, the second embodiment is suitable for a case where a salesperson performs selling by weight while operating the measuring apparatus 10 at a store, as a meat selling by piece. In other words, by using the measuring apparatus 10 of the second embodiment, a sales form in which the salesperson sequentially measures a plurality of pieces of merchandise according to the request of the purchaser, the purchaser causes the two-dimensional code to be read by the reading terminal 20 only once at the last, and the plurality of pieces of merchandise are received from a salesperson can be realized.

In the measuring apparatus 10 for use in the sales form, a display device for displaying a two-dimensional code for the purchaser may be provided separately from the touch panel 13. The measuring apparatus 10 is suitable for use in a store where a salesperson faces a purchaser and performs selling by weight with a sales counter therebetween.

This embodiment can be variously modified as follows.

In the first and second embodiments, the merchandise code and the price specifying data may be output using an optically readable mark other than the two-dimensional code, such as a one-dimensional bar-code or a character string. Alternatively, the merchandise code and the price specifying data may be output by wireless communication using proximity wireless communication or the like. Alternatively, by providing a device that performs communication via the communication network 40 to the measuring apparatus 10, the merchandise code and the price specifying data may be transmitted to the sales processing server 30 via the communication network 40.

In the first and second embodiments, the merchandise table may be managed in association with the purchaser. Then, a behavior of the purchaser is monitored by a sensor such as a camera. If the behavior that the purchaser sets the merchandise placed on the scale pan 15a as the merchandise to be purchased is confirmed, the sales processing server 30 acquires the merchandise code and the price specifying data from the measuring apparatus 10 and may update the merchandise table.

In the first and second embodiments, a part or entire of each function realized by the processor 11 by information processing can also be realized by hardware that executes information processing that is not based on a program such as a logic circuit. Each of the functions can also be realized by combining software control with hardware such as the logic circuit.

In the second embodiment, the processor 11 may perform not the processing of ACT11 and ACT1 to ACT8 but the processing of ACT12 to ACT25.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measuring apparatus, comprising:
a weighing scale configured to measure a weight of merchandise in a space for measurement;
an imaging unit configured to image the space for measurement;
an identification unit configured to identify the merchandise in the space for measurement, based on a feature of the merchandise shown in an image captured by the imaging unit; and
an output unit configured to output predetermined data through which merchandise in the space for measurement and a sales price of the merchandise are specified respectively, based on the weight measured by the weighing scale and an identification result obtained by the identification unit.

2. The apparatus according to claim 1, wherein
the output unit outputs predetermined data through which a plurality of pieces of merchandise sequentially placed in the space for measurement and a sales price of each of the plurality of pieces of merchandise are specified respectively, based on a plurality of weights obtained by a plurality of measurements using the weighing scale and identification results respectively obtained by the identification unit in the plurality of measurements.

3. The apparatus according to claim 2, wherein
the output unit outputs
if a predetermined declaration is not made by an operator, predetermined data through which one piece of merchandise in the space for measurement and a sales price of the merchandise are specified respectively, based on one weight obtained by one measurement using the weighing scale and one identification result obtained by the identification unit in one time of measurement, and
if the declaration is made by the operator, predetermined data through which a plurality of pieces of merchandise sequentially placed in the space for measurement and a sales price of each of the plurality of pieces of merchandise are specified respectively, based on a plurality of weights obtained by a plurality of measurements using the weighing scale and identification results respectively obtained by the identification unit in the plurality of measurements.

4. The apparatus according to claim 1, wherein
the output unit comprises
a display device, and
a control unit configured to cause the display device to display an optically readable code pattern representing the predetermined data.

5. The apparatus according to claim 2, wherein
the output unit comprises
a display device, and
a control unit configured to cause the display device to display an optically readable code pattern representing the predetermined data of the plurality of pieces of merchandise.

6. The apparatus according to claim 1, further comprising:
a payment processing component configured to process payment of the merchandise.

7. The apparatus according to claim 1, further comprising:
a second display device.

8. A system, comprising:
a server comprising predetermined data of a plurality of merchandise; and
a plurality of measuring apparatuses, each measuring apparatus configured to communicate with the server, each measuring apparatus comprising:
a weighing scale configured to measure a weight of merchandise in a space for measurement;
an imaging unit configured to image the space for measurement;
an identification unit configured to identify the merchandise in the space for measurement, based on a feature of the merchandise shown in an image captured by the imaging unit; and
an output unit configured to output predetermined data through which merchandise in the space for measurement and a sales price of the merchandise are specified respectively, based on the weight measured by the weighing scale and an identification result obtained by the identification unit.

9. The system according to claim 8, wherein
each output unit outputs predetermined data through which a plurality of pieces of merchandise sequentially placed in the space for measurement and a sales price of each of the plurality of pieces of merchandise are specified respectively, based on a plurality of weights obtained by a plurality of measurements using the weighing scale and identification results respectively obtained by the identification unit in the plurality of measurements.

10. The system according to claim 9, wherein
each output unit outputs
if a predetermined declaration is not made by an operator, predetermined data through which one piece of merchandise in the space for measurement and a sales price of the merchandise are specified respectively, based on one weight obtained by one measurement using the weighing scale and one identification result obtained by the identification unit in one time of measurement, and
if the declaration is made by the operator, predetermined data through which a plurality of pieces of merchandise sequentially placed in the space for measurement and a sales price of each of the plurality of pieces of merchandise are specified respectively, based on a plurality of weights obtained by a plurality of measurements using the weighing scale and identification results respectively obtained by the identification unit in the plurality of measurements.

11. The system according to claim 8, wherein
each output unit comprises
a display device, and
a control unit configured to cause the display device to display an optically readable code pattern representing the predetermined data.

12. The system according to claim 9, wherein
each output unit comprises
a display device, and
a control unit configured to cause the display device to display an optically readable code pattern representing the predetermined data of the plurality of pieces of merchandise.

13. The system according to claim 8, each measuring apparatus further comprises:
a payment processing component configured to process payment of the merchandise.

14. The system according to claim 8, each measuring apparatus further comprises:
a second display device.

15. A measuring method, comprising:
measuring a weight of merchandise in a space for measurement of a weighing scale;
imaging the space for measurement;
identifying the merchandise in the space for measurement, based on a feature of the merchandise shown in a captured image to provide an identification result; and
outputting predetermined data through which merchandise in the space for measurement and a sales price of the merchandise are specified respectively, based on the weight measured and the identification result.

16. The method according to claim 15, further comprising:
outputting predetermined data through which a plurality of pieces of merchandise sequentially placed in the space for measurement and a sales price of each of the plurality of pieces of merchandise are specified respectively, based on a plurality of weights obtained by a plurality of measurements and identification results respectively obtained in a plurality of measurements.

17. The method according to claim 16, further comprising:
outputting
if a predetermined declaration is not made by an operator, predetermined data through which one piece of merchandise in the space for measurement and a sales price of the merchandise are specified respectively, based on one weight obtained by one measurement using the weighing scale and one identification result in one time of measurement, and
if the declaration is made by the operator, predetermined data through which a plurality of pieces of merchandise sequentially placed in the space for measurement and a sales price of each of the plurality of pieces of merchandise are specified respectively, based on a plurality of weights obtained by a plurality of measurements using the weighing scale and identification results respectively obtained in the plurality of measurements.

18. The method according to claim 15, further comprising:
displaying an optically readable code pattern representing the predetermined data.

19. The method according to claim 16, further comprising:
displaying an optically readable code pattern representing the predetermined data of the plurality of pieces of merchandise.

20. The method according to claim 15, further comprising:
processing payment of the merchandise.
